(19) United States
(12) Patent Application Publication
(10) Pub. No.: US 2009/0167567 A1
(43) Pub. Date: Jul. 2, 2009

(54) METHOD FOR AVOIDING COLLISIONS AND A COLLISION AVOIDANCE SYSTEM

(75) Inventors: Eyal HALPERIN, Givat Ada (IL); Shaked Ben-or, Kfar Shmaryahu (IL); Uri Paz-Meidan, Herzlia (IL)

Correspondence Address: BROWDY AND NEIMARK, P.L.L.C.;624 NINTH STREET, NW, SUITE 300, WASHINGTON, DC, 20001-5303, US

(73) Assignee: Israeli Aerospace Industries Ltd., Lod (IL)

(21) Appl. No.: 11/968,405

(22) Filed: Jan. 2, 2008

(51) Int. Cl. G08G 5/04

(52) U.S. Cl. 340/961; 340/407.1

(57) ABSTRACT

A collision avoidance system, the system comprises a tactile interface device; the tactile interface device comprises a connecting element shaped such as to be worn around a thigh of a pilot; wherein the connecting element is coupled to multiple tactile sensory devices; wherein when the connecting element is worn around a thigh of the pilot the tactile sensory devices are in tactile communication with the pilot; wherein the multiple tactile sensory devices are controlled by a controller; wherein if another plane presents a threat of collision, the controller activates at least one tactile sensory device out of the multiple tactile sensory devices such as to provide a tactile maneuver indication that is indicative of a collision avoidance maneuver.

### FIELD OF THE INVENTION

The invention relates to collision avoidance systems and for methods for avoiding collisions.

### BACKGROUND OF THE INVENTION

The information flow pilots are exposed to during flight influence many aspects of their flight performance. Studies has shown that the response time of the pilot increases as the amount of visual and/or auditory information provided to the pilot increases.

Airborne collision avoidance systems provides the pilot with an indication to the presence of other aircraft, which poses a threat of collision. Where the risk of collision is imminent, the system provides a visual indication (by a display) of a maneuver that can reduce the risk of collision.

A pilot is expected to recognize that his plane is about to collide with another plane, understand that he should perform a maneuver that can reduce the risk of the collision and then perform the evasive maneuver according to the system recommendation. Critical time is lost in this process, especially if the pilot is not looking at the display of the airborne collision avoidance system at the time of the alert.

There is a need to provide an efficient collision avoidance systems and methods for avoiding collisions.

### SUMMARY OF THE INVENTION

A collision avoidance system, the system includes a tactile interface device. The tactile interface device includes a connecting element shaped such as to be worn around a thigh of a pilot. The connecting element is coupled to multiple tactile sensory devices. When the connecting element is worn around a thigh of the pilot the tactile sensory devices are in tactile communication with the pilot. The multiple tactile sensory devices are controlled by a controller. If another plane presents a threat of collision, the controller activates at least one tactile sensory device out of the multiple tactile sensory devices such as to provide a tactile maneuver indication that is indicative to a collision avoidance maneuver.

Conveniently, the collision avoidance system includes an audio unit that provides an audio collision indication. The audio collision indication and the tactile maneuver indication are generated in timing proximity to each other.

Conveniently, the collision avoidance system includes a visual unit that provides a visual maneuver indication presenting the collision avoiding recommended maneuver; wherein the visual maneuver indication and the tactile maneuver indication are generated in timing proximity to each other.

Conveniently, the collision avoidance system includes a visual unit that provides a visual maneuver indication about the collision avoidance maneuver and also includes an audio unit that provides a collision warning. The visual maneuver indication and the tactile maneuver indication are generated in timing proximity to each other.

A tactile interface device that includes a connecting element shaped such as to be worn around a thigh of a pilot. The connecting element is coupled to multiple tactile sensory devices. When the connecting element is worn around a thigh of the pilot the tactile sensory devices are in tactile communication with the pilot. The multiple tactile sensory devices are controlled by a controller. If another plane presents a threat of collision, the controller activates at least one tactile sensory device out of the multiple tactile sensory devices such as to provide a tactile maneuver indication that is indicative of a collision avoidance maneuver.

Conveniently, the controller activates a tactile sensory device out of the multiple tactile sensory devices such as to provide a tactile collision threat indication that is indicative to the location, maneuver and speed of the other plane.

Conveniently, the tactile maneuver indication substantially differs from the tactile collision threat indication.

Conveniently, the connecting element is shaped such as to be positioned between a pilot suit and a thigh of the pilot and wherein the connecting element is made of durable material adapted to withstand sweat and heat.

Conveniently, the connecting element is integrated in a pilot suit.

Conveniently, connecting element surrounds the multiple tactile sensory devices and reduces the exposure of the multiple tactile sensory devices to electromagnetic radiation.

Conveniently, the controller determines a level of a tactile stimuli provided by an activated tactile sensory device in response to forces that are applied on the pilot.

Conveniently, the controller determines a level of a tactile stimuli provided by an activated tactile sensory device in response to a relative location of the activated tactile sensory and a seat on which the pilot is seated.

Conveniently, the controller determines at least one tactile stimuli characteristic selected from a frequency, a level, and a duration in response to at least one maneuver parameter selected from acceleration, timing and velocity.

A method for avoiding collisions, the method includes: determining, by a controller, which tactile sensory device to activate out of multiple tactile sensory devices that are connected to a connecting element that surrounds a thigh of a pilot, such as to provide a tactile maneuver indication that is indicative of a collision avoidance maneuver with another plane that presents a threat of collision; and activating a tactile sensory device in response to the determination.

Conveniently, the method includes generating an audio collision wherein the audio collision indication and the tactile maneuver indication are generated in timing proximity to each other.

Conveniently, the method includes generating a visual maneuver indication about the collision avoidance maneuver; wherein the visual maneuver indication and the tactile maneuver indication are generated in timing proximity to each other.

Conveniently, the method includes generating an audio collision; wherein the audio maneuver indication, the visual maneuver indication and the tactile maneuver indication are generated in timing proximity to each other.

Conveniently, the method includes activating another tactile sensory device out of the multiple tactile sensory devices such as to provide a tactile collision threat maneuver indication that is indicative of a location or speed of the other plane.

Conveniently, the tactile maneuver indication substantially differs from the tactile collision threat indication.

Conveniently, the method includes providing a connecting element that is made of durable material adapted to withstand sweat and heat and placing the connecting element between a pilot suit and a thigh of the pilot.

Conveniently, the method includes providing a connecting element that is integrated in a pilot suit.

Conveniently, the method includes reducing, by the connecting element, an exposure of the multiple tactile sensory devices to electromagnetic radiation; wherein the connecting element surrounds the multiple tactile sensory devices.

Conveniently, the method includes determining a level of a tactile stimuli provided by an activated tactile sensory device in response to forces that are applied on the pilot.

Conveniently, the method includes determining a level of a tactile stimuli provided by an activated tactile sensory device in response to a relative location of the activated tactile sensory and a seat on which the pilot is seated.

Conveniently, the method includes determining at least one tactile stimuli characteristic selected between frequency, level, and duration in response to at least one maneuver parameter selected from acceleration, timing and velocity.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates a collision avoidance system according to an embodiment of the invention;

FIGS. 2a and 2b illustrate various arrangements of tactile sensory devices according to various embodiments of the invention;

FIGS. 3a-3c illustrate tactile interface devices according to various embodiments of the invention;

FIG. 4 illustrates two maneuver tactile indications provided by two tactile interface devices that are worn by two pilot according to an embodiment of the invention;

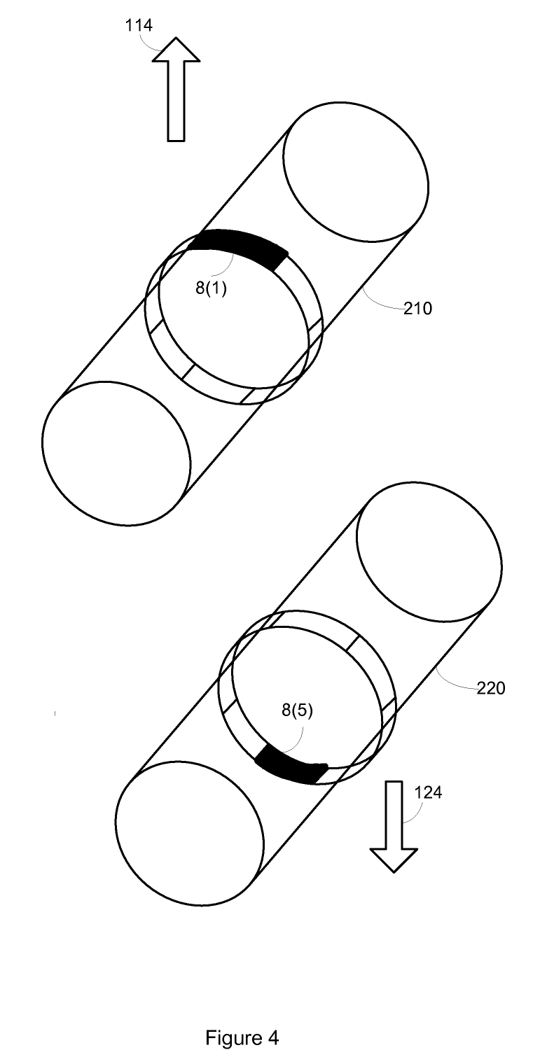

FIG. 5 illustrates a possible collision between two planes, imaginary planes coordinate systems and maneuver tactile generated by two tactile interface devices according to an embodiment of the invention; and

FIG. 6 is a flow chart of a method for avoiding collisions according to an embodiment of the invention.

### DETAILED DESCRIPTION OF EXEMPLARY EMBODIMENTS

A collision avoidance system and a method for avoiding collisions is provided. The system includes a tactile interface device that in turn include multiple tactile sensory devices. The tactile interface device can be worn on a thigh of a pilot. If another plane presents a threat of collision the pilot is provided with tactile maneuver indication that is indicative of a collision avoidance maneuver. Conveniently, if the collision avoidance maneuver requires to direct the plane at a certain direction then one or more tactile sensory devices, that are placed at a location that corresponds to this certain direction, are activated.

The tactile stimuli is immediately recognized by the pilot and because the thigh of the pilot is substantially parallel to the plane's axis, the pilot can easily determine to which direction to fly without performing any substantial directional transformations.

A tactile sensory device includes a vibrator but this is not necessarily so. For example, a tactile sensory device can apply heat or cold to the thigh of the pilot as well apply a non-vibratory pressure on the thigh of the pilot.

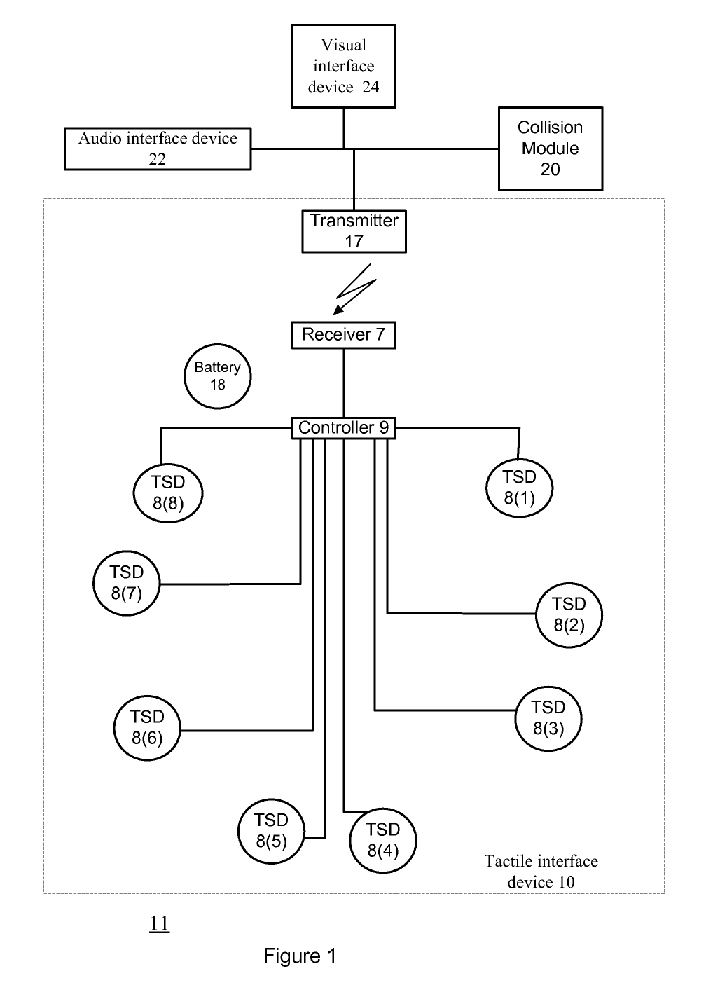

FIG. 1 illustrates collision avoidance system 10 according to an embodiment of the invention.

Referring to FIG. 1, collision avoidance system 10 includes collision module 30, transmitter 17 and tactile interface device 10. Conveniently, and as illustrated in FIG. 1, collision avoidance system 10 also includes audio unit 22 (such as a speakerphone) and a visual unit 24 (such as a screen or a holographic device—Head Up Display—HUD).

Collision module 30 outputs a (non-tactile) maneuver indication. It can also output a (non-tactile) collision indication. The maneuver indication indicates which collision avoidance maneuver to perform. It can indicate to which direction to turn, the speed of the collision avoidance maneuver and/or the acceleration of the collision avoidance maneuver.

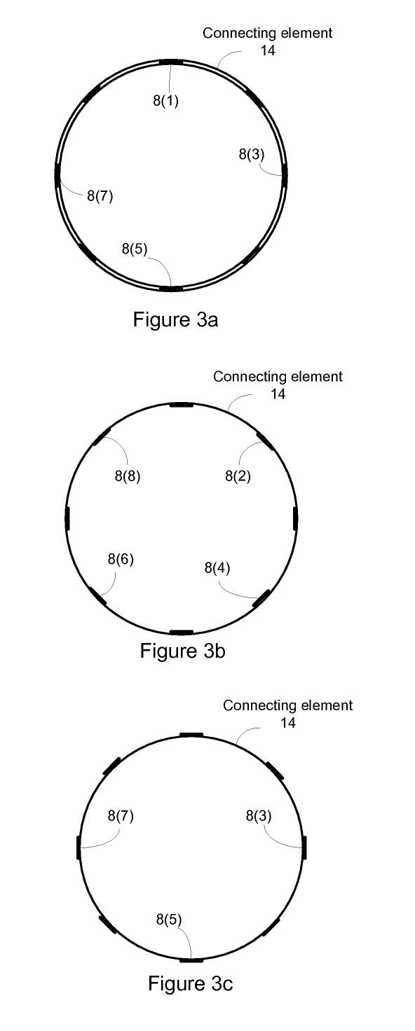

Tactile interface device 10 includes a connecting element (such as connecting element 14 of FIG. 3) that is shaped such as to be worn around a thigh of a pilot. The connecting element can be a belt, a housing, a harness, can be integrated with a pilot suit, be shaped to be positioned between the thigh of the pilot and the pilot suit, can be shaped such as to surround the pilot suit, and the like.

Connecting element 14 can be made of elastic materials or include elastic portions in order to fit itself to the thigh of the pilot. It can also include a buckle, a string or other connecting means that assist in securing connecting element 14 to the thigh of the pilot.

Connecting element 14 can be sweat proof and able to withstand high accelerations and excessive heat.

FIG. 1 illustrates eight tactile sensory devices 8(1)-8(8) that are connected to (or are at least partially surrounded by) connecting element 14. These tactile sensory devices are positioned in various locations that correspond to different directions. Each tactile sensory device “covers” a certain angular range. These angular ranges can be equal to each other but this is not necessarily so. If the pilot, during the collision avoidance maneuver, should direct the plane to a direction that is near a inter-angular range boarder (between two angular ranges) then the two tactile sensory devices that “cover” each of these angular ranges can be activated.

It is noted that although FIGS. 1, 2a, 2b, 3a, 3b and 3c illustrate eight tactile sensory devices that the number of tactile sensory devices can be bigger than eight or smaller then eight.

Conveniently, tactile sensory devices 8(1)-8(8) are surrounded or at least partially surrounded by connecting element 14, and the latter can shield them from electromagnetic radiation such as to reduce the probability of erroneous activation of these tactile sensory devices. FIG. 3a illustrates connecting element 14 that surrounds tactile sensory devices 8(1)-8(8). FIG. 3b illustrates connecting element 14 that is connected to the an exterior side (or portion) of tactile sensory devices 8(1)-8(8). FIG. 3c illustrates connecting element 14 that is connected to an inner side (or portion) of tactile sensory devices 8(1)-8(8). It is noted that connecting element 14 can surround some tactile sensory devices while not surround other tactile sensory devices. For example, tactile sensory devices that are supposed to be located between the thigh of the pilot and the pilot seat can be surrounded by connecting element 14 while other tactile sensory devices are not surrounded by connecting element.

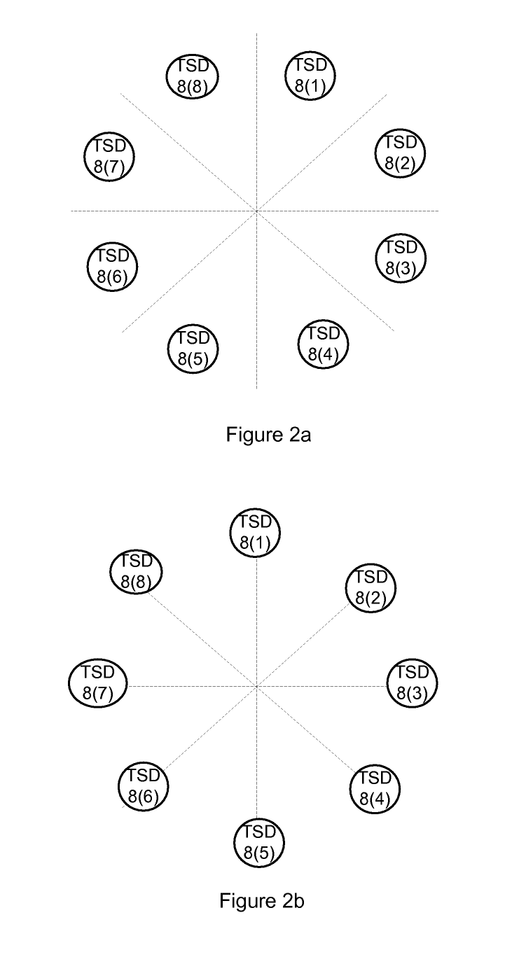

FIG. 2a and FIG. 2b illustrate two arrangements that differ from each other by the angular ranges that are “covered” by each of the eight tactile sensory devices. These arrangements are shifted in relation to each other by about twenty two and a half degrees.

FIG. 2a illustrates tactile sensory device 8(1) as “covering” the angular range of minus twenty two and half degrees till twenty two and half degrees, while other tactile sensory devices cover consecutive angular ranges, each spanning over forty five degrees.

FIG. 2b illustrates tactile sensory device 8(1) as “covering” the angular range of zero to forty five degrees, while other tactile sensory devices cover consecutive angular ranges, each spanning over forty five degrees.

If, for example the pilot is required to turn upwards then in the arrangement illustrated in FIG. 2(a) both tactile sensory devices 8(1) and 8(8) are activated while in the arrangement illustrated in FIG. 2(b) only tactile sensory device 8(1) is activated.

Tactile interface device 11 can include a receiver (such as receiver 7) that receives the maneuver indication from transmitter 17 that in turn is connected to collision module 20. Transmitter 17 and receiver 7 can communicate by using a wireless short range communication channel (such as but not limited to Bluetooth) but this is not necessarily so.

Tactile interface device 10 can also include one or more power sources such as battery 18, in order to supply power to controller 9 and each of the tactile sensory devices.

Controller 9 receives the maneuver indication and in response determines which tactile sensory device to activate and how to active it. The selection is responsive to a direction received from the collision avoidance module. The direction can be a direction of a collision avoidance maneuver.

Controller 9 can determine a level of a tactile stimuli provided by an activated tactile sensory device. The level can be responsive to one or more parameters such as: (i) a required acceleration of a collision avoidance maneuver; (ii) an urgency of a collision avoidance maneuver; (iii) forces that are applied on the pilot, as the tactile stimuli has to be noticeable even under extreme accelerations; and (iv) relative location of the activated tactile sensory and a seat on which the pilot is seated. Conveniently, tactile sensory device located between the thigh of the pilot and the pilot seat should apply a stronger tactile stimuli.

Controller 9 can determine other tactile stimuli characteristic such as frequency and duration in response to at least one maneuver parameter selected from acceleration, timing and velocity.

It can be desirable to provide additional maneuver indications to the pilot, especially provide audio and/or visual maneuver indications that are generated substantially in timing proximity with the tactile maneuver indication. Accordingly, and as illustrated in FIG. 1 an audio maneuver indication can be provided by audio unit 22 and a visual maneuver indication can be provided by visual unit 24.

Yet according to another embodiment of the invention a pilot can receive a tactile maneuver indication as well as a tactile collision threat indication that is indicative of a location or speed of the other plane. The tactile collision threat indication should be substantially different from the tactile maneuver indication. The tactile maneuver indication can be more noticeable than the tactile collision threat indication.

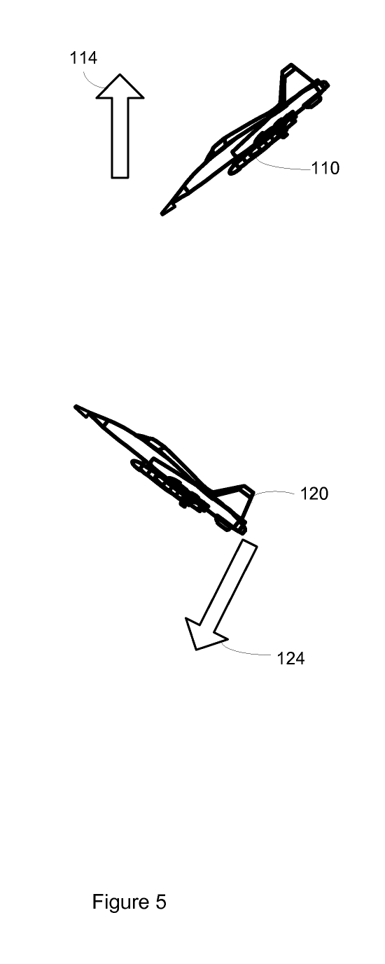

FIG. 5 illustrates a scenario that can lead to a collision of first plane 110 and second plane 120. The pilot of the first plane is equipped with a tactile interface device that is arranged according to the arrangement illustrated in FIG. 2b. The tactile interface device of that pilot is worn around his thigh 210. The pilot of the second plane is equipped with a tactile interface device that is arranged according to the arrangement illustrated in FIG. 2b. The tactile interface device of that pilot is worn around his thigh 220.

In order to avoid a collision plane 110 should turn upwards (receive a turn “UP” tactile maneuver indication 114) while plane 120 should turn downwards (receive a turn DOWN tactile maneuver indication 124).

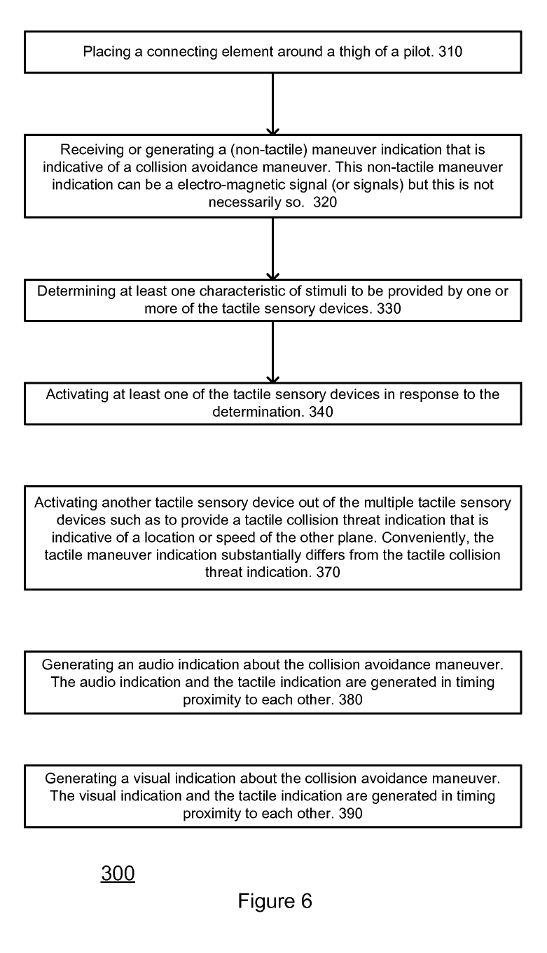

FIG. 6 illustrates method 300 for avoiding collisions according to an embodiment of the invention.

Method 300 starts by stage 310 placing a connecting element around a thigh of a pilot. The connecting element is connected to multiple tactile sensory devices that are in tactile communication with the thigh of the pilot when the connecting element is worn by the pilot. Stage 310 can include adjusting the connecting element to the size of the thigh of the pilot. Referring to the example set fourth in FIG. 3c, stage 310 can include wearing connecting element 14.

Stage 310 is followed by stage 320 of receiving or generating a (non-tactile) maneuver indication that is indicative of a collision avoidance maneuver. This non-tactile maneuver indication can be a electromagnetic signal (or signals) but this is not necessarily so. Stage 320 can include transmitting (for example short range wirelessly transmitting) the non-tactile maneuver indication a receiver that provides this indication to a controller.

Stage 320 is followed by stage 330 of determining at least one characteristic of stimuli to be provided by one or more of the tactile sensory devices. Stage 330 can include determining at least one characteristic of the stimuli by a controller that is connected to the connecting element or is otherwise located in proximity to the connecting element.

Stage 330 can include determining a vibration frequency, determining a vibration duration, determining a vibration level as well as determining which tactile sensory device with provide the stimuli.

The thigh of the pilot is substantially parallel to the plane axis, and is surrounded by multiple tactile sensory devices. Conveniently, stage 330 includes selecting one or more tactile sensory devices that points towards a approximate direction of the maneuver to be taken by the pilot.

Stage 330 is followed by stage 340 of activating at least one of the tactile sensory devices in response to the determination.

According to various embodiments of the invention method 300 includes at least one of the following stages or a combination thereof: stage 370, stage 380 and stage 390. conveniently includes optional stage 380 and, additionally or alternatively optional stage 390.

Stage 370 includes activating another tactile sensory device out of the multiple tactile sensory devices such as to provide a tactile collision threat indication that is indicative of a location or speed of the other plane. Conveniently, the tactile maneuver indication substantially differs from the tactile collision threat indication. According to an embodiment of the invention the tactile maneuver indication is more noticeable than the tactile collision threat indication. For example, it can include much stronger vibrations or a combination of vibrations and yet another tactile stimuli.

Stage 380 includes generating an audio indication about the collision avoidance maneuver. The audio indication and the tactile indication are generated in timing proximity to each other.

Stage 390 includes generating a visual indication about the collision avoidance maneuver. The visual indication and the tactile indication are generated in timing proximity to each other.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

1. A collision avoidance system, the system comprises a tactile interface device; the tactile interface device comprises a connecting element shaped such as to be worn around a thigh of a pilot; wherein the connecting element is coupled to multiple tactile sensory devices; wherein when the connecting element is worn around the thigh of the pilot the tactile sensory devices are in tactile communication with the pilot; wherein the multiple tactile sensory devices are controlled by a controller; wherein if another plane presents a threat of collision, the controller activates at least one tactile sensory device out of the multiple tactile sensory devices such as to provide a tactile maneuver indication that is indicative of a collision avoidance maneuver.

2. The collision avoidance system according to claim 1 comprising an audio unit that provides an audio collision indication; wherein the audio collision indication and the tactile maneuver indication are generated in timing proximity to each other.

3. The collision avoidance system, according to claim 1, comprising a visual unit that provides a visual maneuver indication about the collision avoidance maneuver; wherein the visual maneuver indication and the tactile maneuver indication are generated in timing proximity to each other.

4. The collision avoidance system, according to claim 3, comprising an audio unit that provides an audio collision indication; wherein the audio collision indication, the visual maneuver indication and the tactile maneuver indication are generated in timing proximity to each other.

5. A tactile interface device, comprising: a connecting element, shaped such as to be worn around a thigh of a pilot; wherein the connecting element is coupled to multiple tactile sensory devices; wherein when the connecting element is worn around a thigh of the pilot the tactile sensory devices are in tactile communication with the pilot; wherein the multiple spaced apart tactile sensory devices are controlled by a controller; wherein if another plane presents a threat of collision, the controller activates a tactile sensory device out of the multiple tactile sensory devices such as to provide a tactile maneuver indication that is indicative of a collision avoidance maneuver.

6. The tactile interface device according to claim 5, wherein the controller activates another tactile sensory device out of the multiple tactile sensory devices such as to provide a tactile collision threat indication that is indicative of a location or speed of the other plane.

7. The tactile interface device according to claim 6 wherein the tactile maneuver indication substantially differs from the tactile collision threat indication.

8. The tactile interface device according to claim 5, wherein the connecting element is shaped such as to be positioned between a pilot suit and a thigh of the pilot and wherein the connecting element is made of durable material adapted to withstand sweat and heat.

9. The tactile interface device according to claim 5, wherein the connecting element is integrated in a pilot suit.

10. The tactile interface device, according to claim 5, wherein the connecting element surrounds the multiple tactile sensory devices and reduced an exposure of the multiple tactile sensory devices to electromagnetic radiation.

11. The tactile interface device according to claim 5, wherein the controller determines a level of a tactile stimuli provided by an activated tactile sensory device in response to forces that are applied on the pilot.

12. The tactile interface device according to claim 5, wherein the controller determines a level of a tactile stimuli provided by an activated tactile sensory device in response to a relative location of the activated tactile sensory and a seat on which the pilot is seated.

13. The tactile interface device according to claim 5, wherein the controller determines at least one tactile stimuli characteristic selected from a frequency, a level, and a duration in response to at least one maneuver parameter selected from acceleration, timing and velocity.

14. A method for avoiding collisions, the method comprises: determining, by a controller, which tactile sensory device to activate out of multiple tactile sensory devices that are connected to a connecting element that surrounds a thigh of a pilot, such as to provide a tactile maneuver indication that is indicative of a collision avoidance maneuver with another plane that presents a threat of collision; and activating a tactile sensory device in response to the determination.

15. The method according to claim 14, comprising generating an audio collision; wherein the audio collision indication and the tactile maneuver indication are generated in timing proximity to each other.

16. The method according to claim 14, comprising generating a visual maneuver indication about the collision avoidance maneuver; wherein the visual maneuver indication and the tactile maneuver indication are generated in timing proximity to each other.

17. The method according to claim 16, comprising generating an audio collision; wherein the audio collision indication, the visual maneuver indication and the tactile maneuver indication are generated in timing proximity to each other.

18. The method according to claim 16, comprising activating another tactile sensory device out of the multiple tactile sensory devices such as to provide a tactile collision threat maneuver indication that is indicative of a location or speed of the other plane.

19. The method according to claim 18, wherein the tactile maneuver indication substantially differs from the tactile collision threat indication.

20. The method according to claim 16, comprising providing a connecting element, which is made of durable material adapted to withstand sweat and heat and placing the connecting element between a pilot suit and a thigh of the pilot.

21. The method according to claim 16, comprising providing a connecting element that is integrated in a pilot suit.

22. The method according to claim 16, comprises reducing, by the connecting element, an exposure of the multiple tactile sensory devices to electromagnetic radiation; wherein the connecting element surrounds the multiple tactile sensory devices.

23. The method according to claim 16, comprising determining a level of a tactile stimuli provided by an activated tactile sensory device in response to forces that are applied on the pilot.

24. The method according to claim 16, comprising a determining a level of a tactile stimuli provided by an activated tactile sensory device in response to a relative location of the activated tactile sensory and a seat on which the pilot is seated.

25. The method according to claim 16, comprising determining at least one tactile stimuli characteristic selected between frequency, level, and duration in response to at least one maneuver parameter selected from acceleration, timing and velocity.
